(19) United States
(12) Patent Application Publication
(10) Pub. No.: US 2020/0403294 A1
(43) Pub. Date: Dec. 24, 2020

(54) ANTENNA SYSTEMS AND METHODS FOR PROXIMATE NETWORKS

(71) Applicant: AmpThink, LLC, Garland, TX (US)

(72) Inventor: William C. ANDERSON, III, Garland, TX (US)

(21) Appl. No.: 16/450,572

(22) Filed: Jun. 24, 2019

(51) Int. Cl. H01Q 1/22; H01Q 1/42; H01Q 1/52; A47C 1/121; A47C 7/72; A63J 25/00

(52) U.S. Cl. CPC H01Q 1/2291; H01Q 1/42; A63J 25/00; A47C 1/121; A47C 7/72; H01Q 1/526

(57) ABSTRACT

A system and method for proximate network antennas disposed in cavities in a portion of a seat is disclosed that provides ways to bring antennas closer to the bodies of seat occupants to improve signal to noise ratio and, therefore, throughput and capacity, and to use the bodies of seat occupants to attenuate the signals to improve channel re-use.

### FIELD

The invention generally relates to proximate networks and more specifically to the design, arrangement, and placement of antennas in high density environments.

### BACKGROUND

The history of high density (HD) Wi-Fi deployments in venues such as stadiums and arenas is relatively brief. Venue operators, manufacturers, and integrators have grappled with the particulars of HD Wi-Fi in large open environments even though there are a substantial number of deployments. Each major shift in deployment strategy is intended to increase total system capacity. Significant improvements have come from better antenna technology or techniques that better isolated access point output resulting in improvements in channel re-use.

Designers of first generation HD Wi-Fi networks repurposed concepts of prior deployments used in auditoriums and convention centers focusing on using directional antennas. A goal of this approach was to reduce co-channel interference by reducing the effective footprint of an individual access point's Radio Frequency (RF) output. However, greater improvements came from improving the quality of the link between clients and access points. Better antennas allowed client devices to communicate at faster speeds which decreased the amount of time required to complete their communication, making room for more clients on each channel before a given channel became saturated or unstable.

The concept was limited by the fact that there were few antennas available that could do the job effectively. Designers created hybrid assemblies that combined multiple antennas into arrays that rotated polarization and tightened the antenna beam to paint the smallest usable coverage pattern possible. In time, this gap was addressed and today there are antennas specifically developed for use in overhead HD deployments—so-called Stadium Antennas. Typically, Stadium Antennas are installed in the ceilings above seating and/or on the walls behind seating because these locations are relatively easy to cable and thus minimize cost. Overhead deployments generally suffer from a lack of overhead mounting locations to produce sufficient coverage across the entire venue. For example, in football stadiums the front rows of the lower bowl are typically not covered by an overhang that can be used for antenna placement. These rows are often more than one hundred feet from the nearest overhead mounting location. The result is that pure overhead deployments leave some of the most desirable and most expensive seats in the venue with little or no coverage. Further, due to the length of these sections, antennas at the back of the section potentially service thousands of client devices.

As fans joined these networks, deployments quickly became overloaded and generated service complaints to the venue owners. The problem was addressed by adding antennas at the front of long sections to reduce the total client load on the access points at the back. It somewhat remediated the coverage issue for venues wanting to prioritize for the most important and often most demanding guests however it increased the complexity of installation as it was often difficult to cable access points located at the front of a section. Moreover, placing antennas at the front of long sections are subject to damage by, among other things, fans, direct exposure to weather, and pressure washing cleaning.

With increased complexity, came increased costs as measured by the average cost per installed access point across a venue. Because these types of systems feature antennas at the front and rear of each seating section, these types of deployments are referred to as Front-to-Back Deployments.

System designers further experimented with handrail mounted access points. Using directional antennas, coverage could be directed across a section substantially orthogonal to the forward-facing antennas at the rear of the section and rear-facing antennas at the front of a section. These placements somewhat filled in the gaps in a Front-to-Back Deployment, hence the name In-Fill Deployment.

One of several drawbacks to handrail mounts is that they are expensive and have challenges including but not limited to, safety and disability compliance issues as well as many venues object to the aesthetics of placing enclosures around the handrails. Moreover, mounting access points on handrails require that a hole be drilled in the stadium at each access point location to cable the installed equipment. Other additional costs associated with this approach include using ground-penetrating radar to prepare for coring; enclosure fabrication costs; and more complex conduit and pathway considerations. A typical handrail placement may cost four times the cost of a typical overhead placement and a designer might call for two or three handrail placements for every overhead placement.

In-Fill Deployments improved the coverage problem in large venues. Using a combination of back of section, front of section, and hand-rail mounted access points, designers had a tool box to deliver full coverage. However, with that success came a new problem. As fans discovered these HD networks and found new uses for them, demands on those networks grew rapidly, especially where teams or venue owners pushed mobile-device content strategies that added to the network load. In spite of well-placed access points, fan devices at times did not attach to the in-fill devices at the same rate that they attached to the overhead placements. In-fill equipment remained more lightly used and overhead placements absorbed hundreds of clients. Improvements in system capacity stalled.

To overcome uneven system loading, designers needed to create a more even distribution of RF energy within the deployment. That required a consistent approach to deployment, rather than a mix of deployment approaches. The result was the elimination of overhead antennas in favor of access points and antennas installed within the crowd, closest to the end use; hence the name Proximate Networks.

Proximate networks come in two variations namely, handrail mount only and under-seat only. In the handrail mount only variety, the designer eliminates overhead and front of section placements in favor of a dense deployment of handrail enclosures having access points and antennas. In the under-seat variety, the designer places the access point and the antenna in an enclosure underneath the actual seating but above the steel or concrete decking. In both varieties, the crowd attenuates the signal as it passes through their bodies resulting in consistent signal degradation and even distribution of RF energy throughout the seating bowl. The result is a more even loading of access points and increased system capacity.

An additional benefit of embedding the access points in the crowd is that the crowd effectively constrains the output of the access point much as a wall constrains the output of an access point in a typical building. Each radio therefore hears fewer of its neighbors, allowing each channel to be re-used more effectively. And because the crowd provides an effective mechanism for controlling the spread of RF energy, the radios can be operated at higher power levels which improves the link between the access point and the client devices. The result is a more uniform system loading, higher average data rates, increased channel re-use, and increases in total system capacity.

A drawback however is that placement of the antennas under the seat is suboptimal, usually located under a metal bench or seat pan. Placing the antenna and access point under the seat requires substantially more placement density than other approaches (i.e., more access points/antennas per unit of clients) since the devices are transmitting through the seat pan to reach the client devices.

Therefore, there is a need for the design, arrangement, and placement of antennas and access points configured for proximate networks to optimize performance in high density environments.

### SUMMARY OF THE INVENTION

Features and advantages of the invention will be set forth in the description which follows and can be realized by means of the disclosed instrumentalities and combinations as set forth in detail herein.

In one embodiment, systems and methods are described for housing a network antenna in a cavity formed in a seat back connectable to a network access point mounted beneath the seat base.

In another embodiment, systems and methods are described for creating a first cavity in a seat back for housing a network antenna connectable to a network access point mounted in a second cavity formed in the seat base.

### BRIEF DESCRIPTION OF THE DRAWINGS

A particular description of the principles briefly described above will be rendered by reference to specific embodiments thereof, which are illustrated in the appended drawings. Understanding that these drawings depict only certain exemplary embodiments of the disclosure and are not therefore to be considered to be limiting of its scope, the principles herein are described and explained with additional specificity and detail through the use of the accompanying drawings.

FIG. 1 is an illustration of a stadium depicting Wi-Fi coverage in a stadium using prior art systems and methods.

FIG. 2 is a side view of an exemplary seat and its constituent components having an antenna mounted in a seat back, in accordance with the principles of the present invention.

FIG. 3 is a rear view of an exemplary seat and its constituent components having an antenna mounted in a seat back connected to an access point situated beneath the exemplary seat.

FIG. 4 is a rear view of an exemplary seat and its constituent components having an antenna mounted in a seat back connected to an offset access point situated beneath the exemplary seat.

FIG. 5 is a rear view of an exemplary seat and it constituent components having an antenna mounted in a seat back connected to an access point mounted in a seat bottom.

FIG. 6 is an exploded view of an exemplary seat back in accordance with the present invention, shown a seat back having one or more cavities for receiving a seat back antenna and/or other components.

FIG. 7 illustrates Radio Frequency (RF) elevational coverage in an exemplary seating section, wherein some seats include RF antennas located in said seats, in accordance with the present invention.

FIG. 8 is a depiction of a stadium having multiple seating sections, and an example distribution of seats that include a network antenna stored therein, in accordance with the present invention.

FIG. 9 is a perspective view of a section of seats showing an example distribution of seats that include a network antenna stored therein, in accordance with the present invention.

FIG. 10 is a representation of a distributed antenna network splitting the transmitted power among several antenna elements separated in space so as to provide coverage over the same area as a single antenna in accordance with the principles of the present invention.

FIG. 11 is an azimuth graph of coverage for a typical antenna mounted in a stadium seat back.

FIG. 12 is an elevation graph of coverage for a typical antenna mounted in a stadium seat back.

FIG. 13 is a depiction of Wi-Fi coverage in a stadium using the techniques shown and described herein.

### DETAILED DESCRIPTION

The figures and text below, and the various embodiments used to describe the principles of the present invention are by way of illustration only and are not to be construed in any way to limit the scope of the invention. A Person Having Ordinary Skill in the Art (PHOSITA) will readily recognize that the principles of the present invention maybe implemented in any type of suitably arranged seating. More specifically, while the present invention is described with respect for use in high density Wi-Fi deployments, a PHOSITA will readily recognize other types of wireless communication systems such as but not limited to, cellular mobile devices (e.g. 5G, LTE, etc.) and other communication protocols and applications without departing from the scope of the present invention. Unless defined otherwise, all technical and scientific terms used herein have the same meaning as commonly understood by a PHOSITA in fields of the present invention. It is to be understood that the terminology used herein is for the purpose of describing particular embodiments only, and is not intended to be limiting.

Reference throughout this specification to “one embodiment,” “an embodiment,” “a specific embodiment,” or “particular embodiment” means that a particular feature, structure, or characteristic described in connection with the particular embodiment is included in at least one embodiment and not necessarily in all particular embodiments. Thus, respective appearances of the phrases “in a particular embodiment,” “in an embodiment,” or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Reference is now made to the figures, which depict, inter alia, various views of a typical stadium seat that has been adapted for use in accordance with the present invention in a proximate network within a large venue including but not limited to, a stadium, arena, or auditorium. Prior to adaptation in accordance with the present invention, the seat may, by way of example and not limitation, be a stadium, arena, or auditorium variety. While the present invention contemplates stadium, arena, or auditorium style seats, it is to be understood that other seats having backs can be adapted for use with the present invention.

The present invention may be incorporated into newly manufactured seats or applied to existing installed seating through the retrofitting of the seat with a replacement seat back adapted in accordance with the present invention. By way of example, existing head portion or lumbar portion, or both, of seat back could be replaced with a replacement having a cavity formed therein—thus providing in-field retrofitting without having to remove or replace the existing seat. Moreover, since a manufacturer is already typically fabricating a molded plastic seat back shell, the addition of further adding a cavity to the mold does not result in substantially increasing manufacturing or material costs.

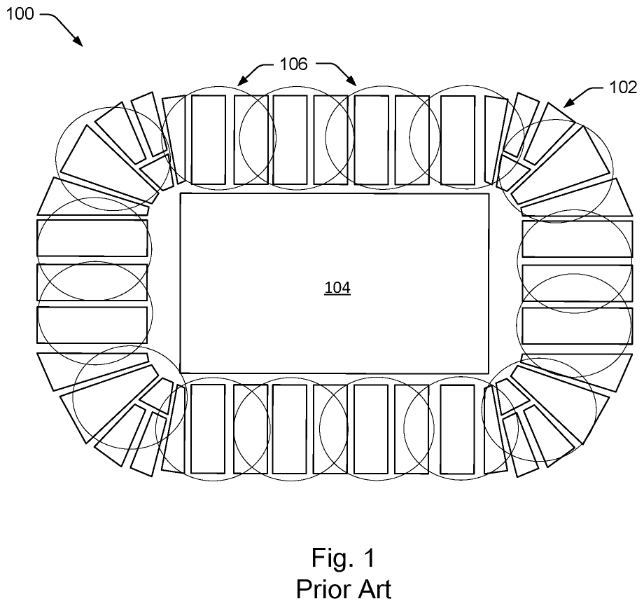

FIG. 1 is an illustration of a stadium 100 depicting Wi-Fi coverage in a stadium using prior art systems and methods. The stadium 100 includes multiple sections of stands 102, each depicted as a trapezoid, surrounding a playing field 104. Multiple circles 106 are shown in FIG. 1, each depicting Wi-Fi coverage from a Wi-Fi network antenna, such as a stadium (overhead) antenna. In such a prior art system, a single antenna covers a relatively large area and, thus, many spectators and up to thousands of Wi-Fi devices. Such a configuration leaves networks susceptible to rapid overloading and deterioration of services, thus providing a sub-optimal experience for users. The techniques described herein can be deployed to avoid such a situation.

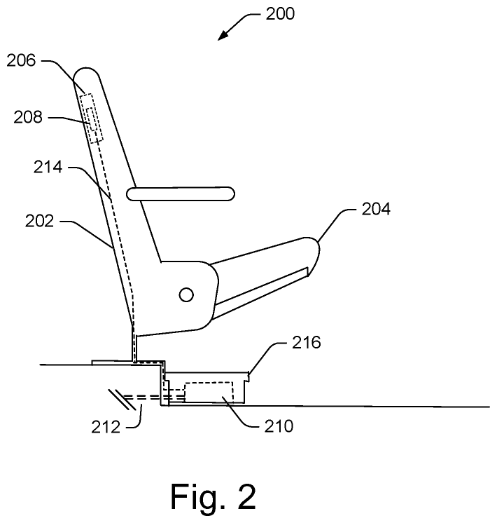

FIG. 2 is a side view of an exemplary seat 200 in accordance with the principles of the present invention. The exemplary seat 200 includes a seat back 202 and a seat base 204. The seat back 202 and the seat base 204 are preferably made of a rigid or semi-rigid material such as plastic, metal, wood, fiber, composite material, or the like. A cushion (not shown) may be included with or disposed on the seat back 202 or the seat base 204. In various embodiments, the seat back 202 may be rigid or semi-rigid with minimal flexibility to protect one or more electronic components (such as an antenna) mounted within the cavity, or it may be flexible contain an electronic component that is fabricated on a flexible substrate mounted within the cavity, permitting it to bend without damage as the seat back 202 bends. The seat back 202 has a cavity 206 located therein, in which an antenna 208, such as a Wi-Fi antenna, is disposed. In at least one alternate embodiment, the antenna 208 may be attached to a portion of the seat back 202 rather than being disposed within a cavity in the seat back 202.

The present invention may be incorporated into newly manufactured seats or applied to existing installed seating through the retrofitting of the seat with a replacement seat back adapted in accordance with the present invention. By way of example, an existing portion of a seat back could be replaced with a replacement having a cavity formed therein, thus providing in-field retrofitting without having to remove or replace an existing seat. Moreover, since a manufacturer is already typically fabricating a molded plastic backseat shell, the addition of further adding a cavity to the mold does not result in substantially increasing manufacturing or material costs.

The antenna 208 may be any type of antenna known in the art, such as a Wi-Fi antenna, radio antenna, or the like. However, the present description focuses on embodiments that utilize a Wi-Fi antenna. Any type of Wi-Fi antenna may be utilized with the presently described techniques, such as a directional patch antenna, a multiple-input and multiple-output (MIMO) patch antenna formed on a substrate designed to operate with MIMO access points, a broad beam omni directional antenna dipole rod formed on a substrate for Wi-Fi networks, or the like. In embodiments having a flexible seat back as anticipated by the description provided herein, the antenna 208 can be formed or etched on conductive clad (e.g., copper) flexible plastic substrates, such as polyimide, PEEK or transparent conductive polyester film. One skilled in the art will recognize other suitable antennas and/or materials without departing from the scope and spirit of the present invention.

A network access point 210 is disposed beneath the seat back 202 and is communicatively connected to a wired network 212. Generally, and as used herein, an access point is a hardware networking device that allows Wi-Fi devices to connect to a wired network. An access point connects directly to a wired local network, such as Ethernet, and the access point provide wireless connections for other devices to use that wired connection.

While the access point 210 can be mounted to a foundation to which the seat 200 is mounted, any suitable location may be used to mount the access point 210. For example, the access point 210 may be mounted to the bottom surface of the seat base 204 or within the seat base 204 itself. The antenna 208 is communicatively connected to the access point 210 by an appropriate data/power cable 214. In the embodiment shown, the access point 210 is located within a protective enclosure 216 that protects the access point 210 from potentially harmful occurrences, such as extreme weather, moisture, shock from impact from a seat user, etc.

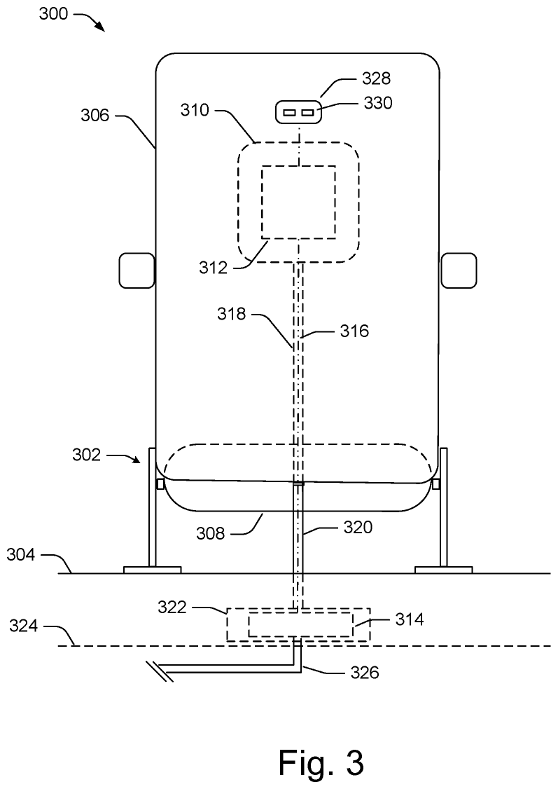

FIG. 3 is a rear view of an exemplary seat 300 in accordance with the techniques described herein. The exemplary seat 300 is supported by stanchions 302 secured to a foundation upper level 304. The exemplary seat 300 includes a seat back 306 and a seat base 308. A cavity 310 is formed in the seat back 306, and a Wi-Fi antenna 312 is disposed in the cavity 310. The Wi-Fi antenna 312 is communicatively connected to an access point 314 by a data/power cable 316 disposed within a data channel 318 formed in the seat back 306. The data/power cable 316 extends through a protective conduit 320 from the seat back 306 to a protective enclosure 322 in which the access point 314 is housed. The protective enclosure 322 is secured to a foundation lower level 324. The access point 314 is connected to and communicates with a wired network 326. In one or more embodiments, an accessory port 328 is formed in the seat back 306, through which accessories such as USB port(s), Ethernet port(s), power port(s), etc., may be accessed. The embodiment shown in FIG. 3 includes a pair of USB ports 330 through which users can directly connected electronic devices.

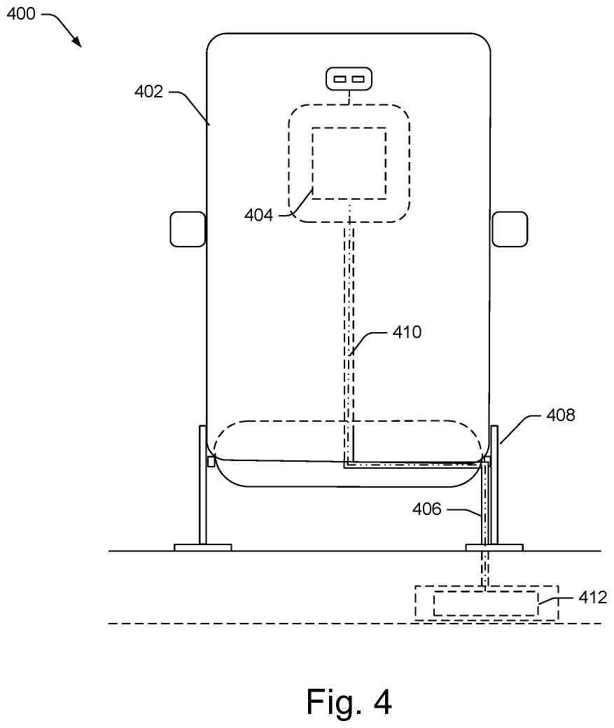

FIG. 4 is a rear view of an exemplary seat 400 in accordance with the techniques described herein. The exemplary seat 400 is similar to the exemplary seat 300 shown in and described with respect to FIG. 3, and includes a seat back 402 having a Wi-Fi antenna 404 disposed therein. Whereas the exemplary seat 300 shown in FIG. 3 includes a protective conduit 320 that extends generally downward from an approximate center of seat back 302, the exemplary seat 400 (FIG. 4) includes a protective conduit 406 that is offset so as to be securable against a seat stanchion 408. This particular embodiment provides additional protection for a data/power cable 410 that extends from the Wi-Fi antenna 404 to an access point 412 disposed beneath the exemplary seat 400.

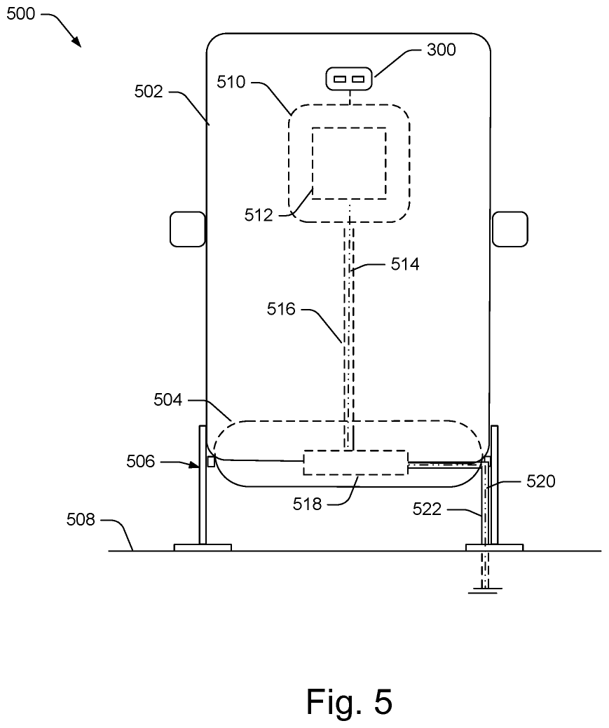

FIG. 5 is a rear view of an exemplary seat 500 in accordance with the techniques described herein. The exemplary seat 500 includes a seat back 502 and a seat base 504. The exemplary seat 500 is supported by stanchions 506 secured to a foundation 508. The seat back 502 includes a cavity 510 formed therein, in which a Wi-Fi antenna 512 is disposed. A data/power cable 514 extends from the Wi-Fi antenna 512 through a cable channel 516 to an access point 518 located inside the seat base 504. The access point 518 is connected to a remote power source (not shown) and a remote data source (not shown) by way of a data/power cable 520 that extends through a protective conduit 522. The exemplary seat 500 is similar to the exemplary seat 400 shown in and described with respect to FIG. 4, except that the access point 518 is located in the seat base 504. It is noted that, although the access point 518 is shown being wholly contained in the seat base 504, it may be connected to a bottom of the seat base 504, in which case the access point 518 may be located wholly or partially outside the seat base 504.

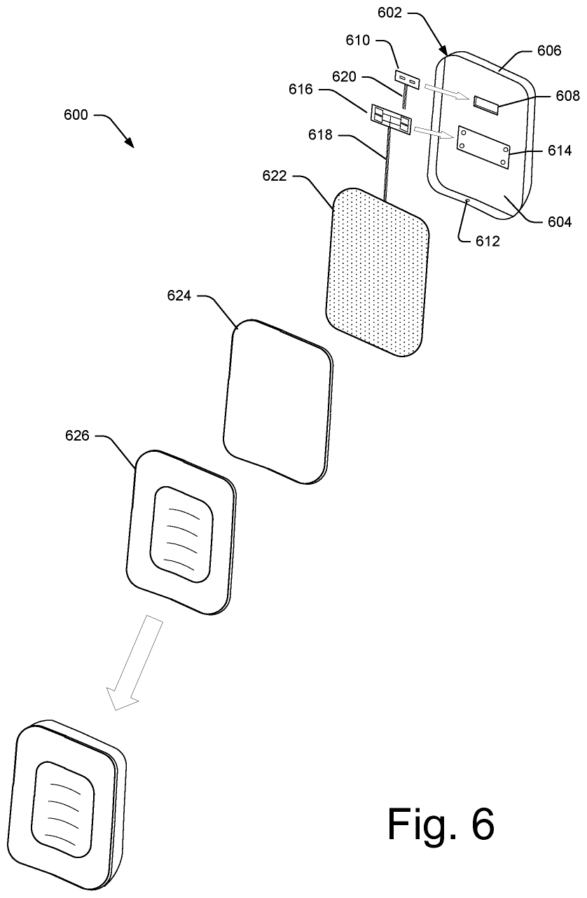

FIG. 6 is an exploded view of an exemplary seat back 600 and its components in accordance with the techniques described herein. Although the exemplary seat back 600 is shown as including particular components, one or more of the components shown may be omitted from a particular implementation that embodies the novel techniques described herein. Likewise, one or more additional components may be included in an alternate embodiment in accordance with the present invention.

The exemplary seat back 600 includes a shell portion 602 that is designed to secure other components of the seat back 600. The shell portion 602 has a cavity 604 formed therein. In this particular embodiment, the cavity 604 is formed by a shell wall 606 that extends around a perimeter of the shell portion 602. It is noted, however, that the cavity 604 may be formed by any other technique known in the art. For example, a molded insert may be disposed in the shell portion 602 that has a cavity molded therein that more closely fits the shape of an antenna and/or other components to be included therein. In the embodiment presently described, such components are shown affixed to the shell portion 602. The shell portion 602 is shown having a peripheral port 608 formed therein, that is configured to expose one or more peripheral device interfaces 610 for one or more peripheral devices (not shown). The shell portion 602 also includes a cable access aperture 612 thorough which a data and/or power cable may extend to connect components disposed within the shell portion 602 to data and/or power sources that are external to the shell portion 602.

A component mount 614 is shown disposed within and affixed to the shell portion 602 and is configured to secure one or more electronic components to the shell portion 602. A Wi-Fi antenna 616 is mounted to the component mount 614, and is connected to an access point (not shown) by a data/power cable 618. The component mount 614 is configured to hold the Wi-Fi antenna 616 in one of several positions, allowing the Wi-Fi antenna 616 to be tilted to an extent appropriate for a given setting. A secondary data/power cable 620 supplies the peripheral device interfaces 610. Although the present figure only shows a Wi-Fi antenna 616 and peripheral device interfaces 610 located in the exemplary seat back 600, it is noted that one or more other electronic components may also be disposed therein, such as a Bluetooth radio antenna (IEEE standard 802.15), etc.

To facilitate even access point loading and to protect a person sitting adjacent to the exemplary seat back 600 from possibly harmful levels of radiation, the exemplary seat back 600 preferably includes a Radio Frequency (RF) shield element 622. The RF shield element 622 attenuates signals in one direction, thus inhibiting connection to devices serviced by an access point other than one connected to the Wi-Fi antenna 616. In addition, the RF shield element 622 mitigates exposure of a person situated next to the seat back 600 to RF energy. The blocking or absorbance of radio frequency signals by the RF shield element is determined by many factors such as the material used, the conductivity of the material, the material thickness, the permeability of the material, etc. The RF shield element 622 may be a material such as a metallized shielding fabric combining highly conductive metals with the flexibility and light weight of fabric to meet a range of EMI (Electro-Magnetic Interference) and/or RF shielding requirements. The element may be made of, although not exclusively, nickel/copper to provide shielding effectiveness and surface conductivity as well as accommodating complex contours and shapes for diverse shielding applications. In an alternate embodiment, the RF shield element 622 may be manufactured into a substrate of the Wi-Fi antenna 616.

A padding element 624 is also included in the exemplary seat back 600. The padding element 624 is an optional element depending on the nature of the construction of the exemplary seat back 600. In one or more embodiments, the RF shield element 622 and the padding element 624 may be incorporated into a single element. The exemplary seat back 600 also includes a front face 626, which is configured to be seated to the shell portion 602 of the exemplary seat back 600 and sealed such that components disposed within the shell portion 602 are protected from external elements, such as moisture. In at least one embodiment, the front face 626 is removably attached to the shell portion 602 of the exemplary seat back 600, to allow access to the components inside the shell portion 602 for maintenance. For example, the front face 626 can be removed to access the Wi-Fi antenna 616 and the component mount 614 to adjust an angle of the Wi-Fi antenna 616 to fine tune a direction of radiation from the Wi-Fi antenna 616.

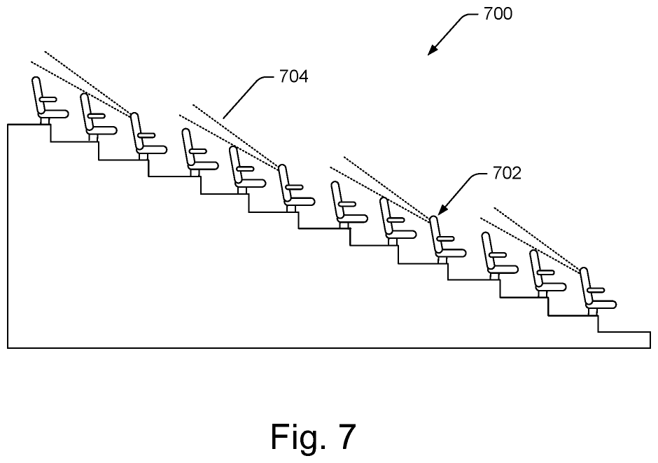

FIG. 7 depicts a side view of an exemplary seating section 700 that includes a plurality of seats 702, some of which include a Wi-Fi antenna (not shown) incorporated therein, in accordance with the present invention. Radio frequency (RF) signals 704 illustrate elevational Wi-Fi coverage in the exemplary seating section 700. As can be seen in the illustration shown in FIG. 7, signal coverage from each seat back antenna is distributed in a substantially rearward direction, such that a smaller set of users than with typical systems access a particular access point. Furthermore, since the RF signals 704 do not extend in a forward direction, it is less likely that devices in a particular area covered by a Wi-Fi antenna and access point will connect to access points intended for use by a limited, other set of devices. As such, the presently described techniques prevent overloading of access points and provide a more satisfactory user experience than current systems provide.

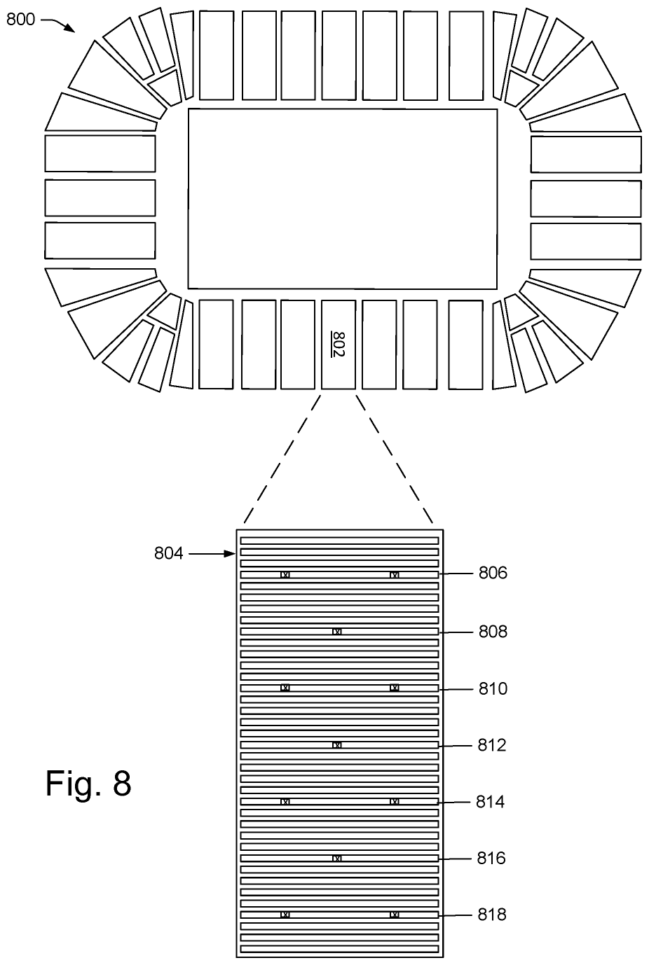

FIG. 8 is a depiction of a stadium 800 having multiple seating sections, and an example distribution of seats that include a network antenna stored therein, in accordance with the present invention. The stadium 800 includes section 802, which is shown in an expanded view. Section 802 includes multiple rows 804 of seats, some of which include network antennas, indicated by the character “X.” Although networks antennas (“X”) are not shown located forward of row 806 in FIG. 8, it is noted that network antennas (“X”) may be place in seats in any row that is practicable for the application. As shown in the present example, network antennas (“X”) are shown located in row 806, row 808, row 810, row 812, row 814, row 816, and row 818. In different implementations, network antennas may be located in more or fewer rows than shown in the present example. The network antennas (“X”) are shown distributed in a staggered arrangement, wherein alternating rows include two antennas and one antenna, respectively. In alternate embodiments, such an arrangement may be different. The example shown in FIG. 8 is illustrative as to one way in which network antennas (“X”) may be distributed throughout a section of stadium seats.

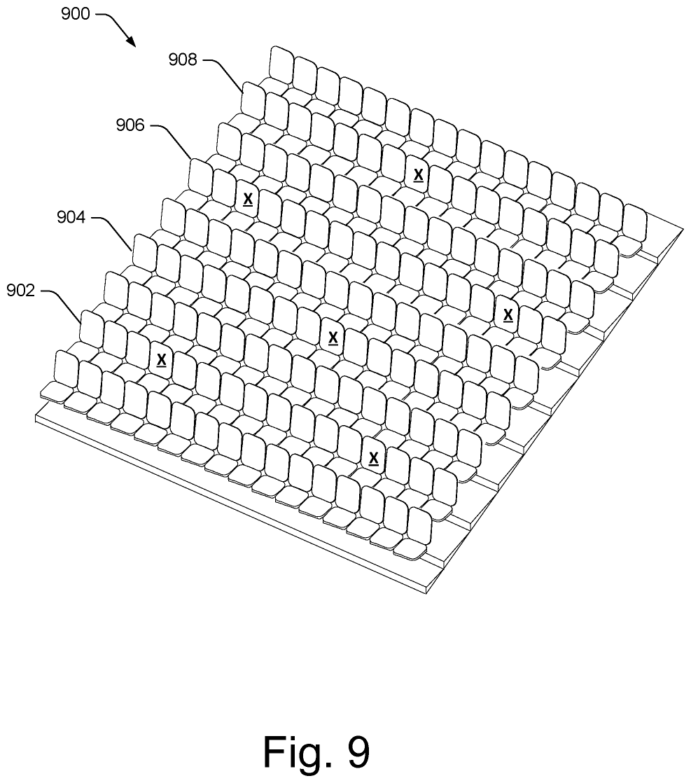

FIG. 9 is a perspective view of an exemplary seating section 900 showing an example distribution of seats that include a network antenna stored therein, in accordance with the present invention. Similar to the example shown in FIG. 8, above, the exemplary seating section 900 illustrates one way in which network antennas (indicated by the character “X”), which are located in seat backs, may be distributed throughout a seating section. Alternative embodiments may be used, depending on the logistics and different situations. Network antennas (“X”) are located in seat back in row 902, row 904, row 906, and row 908. Such a distribution allows access points to be located proximal to devices used by persons sitting in the seats and helps to prevent overloading of individual access points.

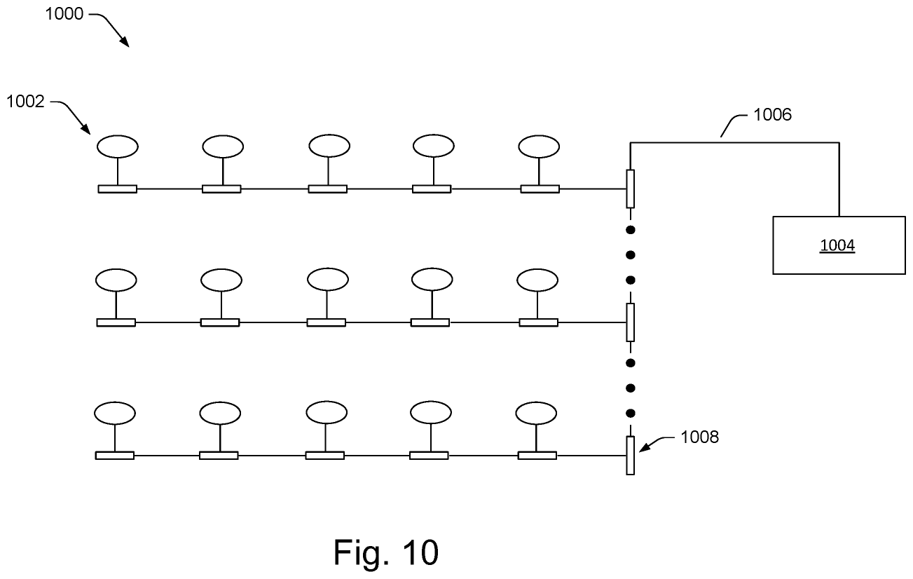

FIG. 10 is a representation of a distributed antenna network 1000 splitting transmitted power among several antennas 1002 separated in space so as to provide coverage over the same area as a single antenna (not shown) in accordance with the principles of the present invention. Such distribution reduces an amount of power required to cover a similar amount of area, and improves reliability by decreasing overloading of access points. As previously noted, multiple proximate network antennas 1002 are contemplated by the presently described techniques to replace a single network antenna as used in prior implementations. The distributed antenna network 1000 represented in FIG. 10, is an arrangement that can replace a prior art system that utilizes fewer network antennas but provides less desirable coverage. The depiction in FIG. 10 is but one example of many different arrangements that can be implemented.

A power/data source 1004 receives electrical power and network data from sources typical to a network environment. The power/data source 1004 may be a Main Distribution Frame (MDF) or an Intermediate Distribution Frame (IDF) that is connected to an MDF. Power/data cables 1006 connect the power/data source 1004 to the antennas 1002 by way of several connector nodes 1008 that are used to join intersections of power/data cables 1006. The power/data cables 1006 may be discrete power cables and data cables, or a standardized twisted pair cable for networks that carries both power and data, such as Cat 3, Cat 5/5e, Cat 6, Cat 6A, etc. A density of the network antennas 1002 may be dependent on the type of cable used to supply power and/or data to the network antennas 1002 due to maximum lengths associated with particular types of cables. For example, Cat 6 cable has a maximum length of fifty-five meters (55 m) while Cat 6A cable has a maximum length of one hundred meters (100 m).

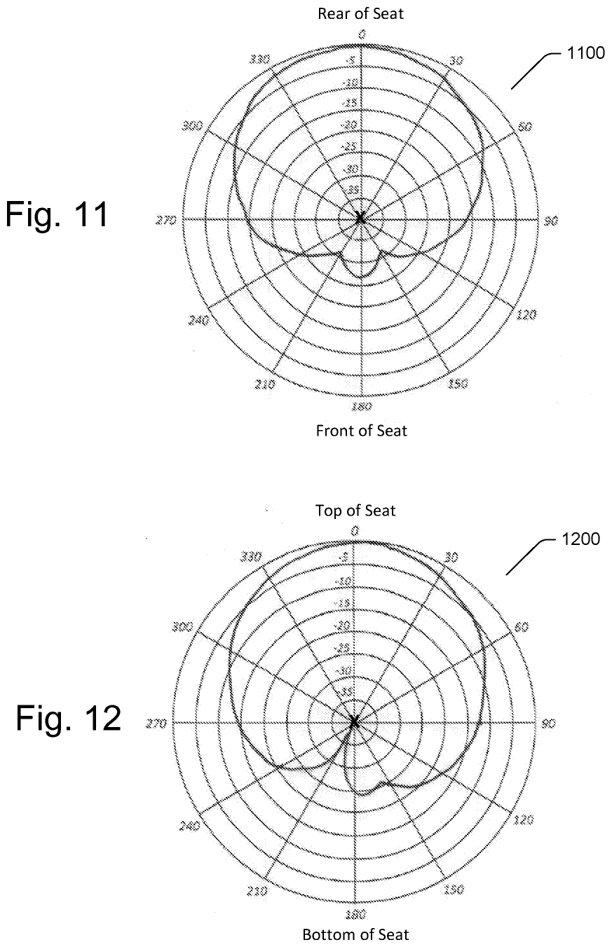

FIG. 11 is an azimuth plot 1100 (also known as a horizontal polar plot) depicting horizontal RF coverage for a network antenna (indicated by character “X”) mounted in a stadium seat back (not explicitly shown). The azimuth plot 1100 indicates that the intensity of radiated power from the antenna disposed within a seat back extends primarily in a direction to a rear of the seat, the direction in which the antenna (“X”) faces. Relatively little power extends toward a front of the seat back. Such a pattern increases the likelihood that devices can connect to an appropriate access point and prevent overloading access points.

FIG. 12 is an elevation plot 1200 (also known as a vertical polar plot) depicting vertical RF coverage for a network antenna (indicated by character “X”) mounted in a stadium seat back (not explicitly shown). The elevation plot 1200 indicates that the intensity of radiated power from the antenna disposed within the seat back extends primarily in a direction toward the top of the seat. Relatively little power extends toward a bottom of the seat back.

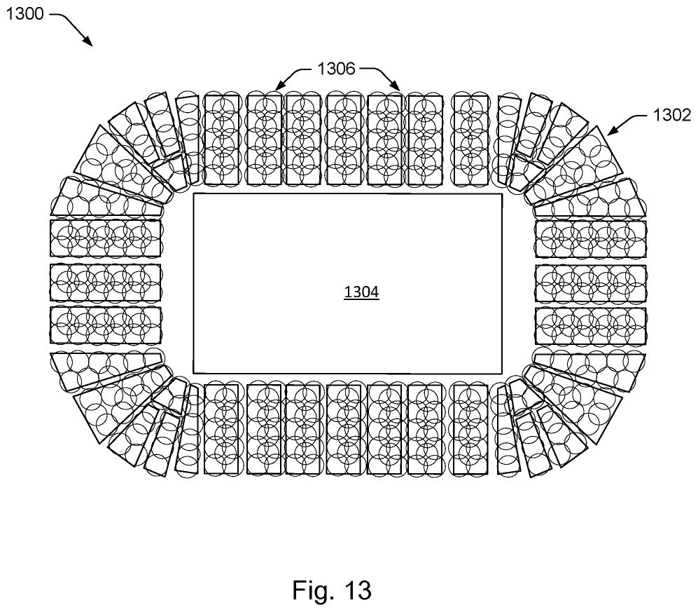

FIG. 13 is a depiction of Wi-Fi coverage in a stadium 1300 using the techniques shown and described herein. The stadium 1300 includes multiple sections of stands 1302, each depicted as a trapezoid, surrounding a playing field 1304. Multiple circles 1306 are shown in FIG. 13, each depicting Wi-Fi coverage from a Wi-Fi network antenna located in a seat back of a seat in the stadium 1300. The stadium 1300 depicted in FIG. 13 is comparable to the prior art depiction of Wi-Fi coverage in the stadium 100 shown in and described relative to FIG. 1. The result of the coverage depicted in FIG. 13 is an improved user experience of using an electronic device to connect to a Wi-Fi network.

### CONCLUSION

While the invention is described with respect to certain embodiments and generally associated methods, alterations and permutations of these embodiments and application to any large venue such as a stadium, arena, or auditorium, one skilled in the art will recognize application to seating in theaters, concert halls and other large venues without departing from the scope of the invention. Accordingly, the above description of example embodiments does not define or constrain this disclosure. Other changes, substitutions, and alterations are also possible without departing from the spirit and scope of this disclosure, as defined by the following claims.

What is claimed is:

1. A seat having an antenna disposed therein.

2. The seat as recited in claim 1, further comprising a seat back, and wherein the antenna is disposed inside the seat back.

3. The seat as recited in claim 1, wherein the antenna further comprises a Wi-Fi antenna.

4. The seat as recited in claim 1, wherein the antenna further comprises a radio antenna.

5. The seat as recited in claim 1, wherein the antenna is connected to a network access point located external to the seat.

6. The seat as recited in claim 1, wherein the antenna is connected to a network access point located in the seat.

7. The seat as recited in claim 6, further comprising a seat back and a seat base, and wherein:
the antenna is disposed inside the seat back; and
the network access point is disposed inside the seat base.

8. The seat as recited in claim 1, further comprising one or more network access ports disposed therein.

9. The seat as recited in claim 8, wherein the one or more network access ports disposed therein further comprises Universal Serial Bus ports.

10. The seat as recited in claim 1, further comprising a Radio Frequency (RF) shield component disposed therein.

11. The seat as recited in claim 10, wherein the RF shield component is disposed between the antenna and a seating portion of the seat.

12. The seat as recited in claim 1, wherein the antenna is moveable to one of multiple fixed positions.

13. A seat back, comprising:
a shell portion forming a cavity;
an antenna mounted in the cavity; and
a front face removably attached to the shell portion to substantially seal the antenna inside the seat back.

14. The seat back as recited in claim 13, wherein the antenna further comprises a Wi-Fi antenna.

15. The seat back as recited in claim 13, further comprising a data/power cable connected to the antenna and extending to a point outside the shell portion of the seat back.

16. The seat back as recited in claim 13, further comprising one or more network access ports contained in the shell portion and disposed such that the access ports are accessible from outside the shell portion.

17. A method, comprising installing an antenna inside a seat back.

18. The method as recited in claim 17, further comprising assembling seat back components such that the antenna is substantially sealed inside the seat back.

19. The method as recited in claim 17, wherein the seat back is an assembled seat back, the method further comprising:
disassembling one or more components of the seat back; and
assembling the one or more components of the seat back components such that the antenna is substantially sealed inside the seat back.

20. The method as recited in claim 17, wherein the seat back further comprises a component mount, and the method further comprises mounting the antenna on the component mount.
